(19) United States
(12) Patent Application Publication
(10) Pub. No.: US 2015/0317385 A1
(43) Pub. Date: Nov. 5, 2015

(54) SCALABLE AND DISTRIBUTED BUSINESS OBJECT CONFIGURATION PROPERTIES

(71) Applicant: Wenli Zhang, San Jose, CA (US)

(72) Inventor: Wenli Zhang, San Jose, CA (US)

(21) Appl. No.: 14/267,173

(22) Filed: May 1, 2014

(51) Int. Cl. G06F 17/30; G06F 3/0484

(52) U.S. Cl. CPC G06F 17/30607; G06F 3/04845; G06F 17/30292; G06F 17/30318

(57) ABSTRACT

According to some embodiments, a method and an apparatus of defining a business object comprises receiving a business object type and a business object sub-type associated with the business object type. A business object based on the business object type and the business object sub-type is defined and the business object is saved.

### BACKGROUND

A graphical user interface (“GUI”) is a user interface that allows users to interact with a computing device by directly manipulating displayed GUI elements, such as input fields, graphical icons and visual indicators (e.g., buttons, tabs, etc.). A GUI may be supported in a backend by business objects associated with one or more applications.

Currently, most conventional applications have limited property handling abilities especially when it comes to complicated properties situations. Conventional applications may not be suitable for handling large scale business object configuration scenarios and thus, conventional applications may become more problematic as business object properties become greater over time.

### BRIEF DESCRIPTION OF THE DRAWINGS

FIG. 1 illustrates a method according to some embodiments.

FIG. 2 illustrates distributed and layered properties of a business object according to some embodiments.

FIG. 3 illustrates a flow diagram according to some embodiments.

FIG. 4 illustrates a system flow according to some embodiments.

FIG. 5 illustrates a system according to some embodiments.

FIG. 6 illustrates an apparatus according to some embodiments.

FIG. 7 illustrates a business object configuration properties according to some embodiments.

### DETAILED DESCRIPTION

The present embodiments relate to a method, apparatus and system to configure business object properties (e.g., configuration properties). More specifically, this invention relates to the management of complicated business object properties rendering associated with a user interface (“UI”), saving business objects (e.g., persistence) and editing business objects. The present embodiments may provide a flexible solution for applications that require business object handling to create a specific user interface for a customer's and an application's needs in a distributed way which may make the present embodiments a scalable and flexible business object properties handling solution.

In general, the present embodiments relate to creating, editing and rendering a business object associated with a user interface. Creating a business object may start with selecting an object type and one or more sub-types. Then, based on the selected type and sub-type(s), view elements are chosen. View elements may comprise the elements of the business object that are rendered in a user interface. Rendered business objects may be used in any page of a user interface based on a selected business object type/sub-types. In some embodiments, this may define a distributed feature of the business object properties rendering. Before the view elements are rendered, a determination is made if default values should be assigned to the particular view elements. The determination may be based on a particular user situation. For example, a default value may be used in a case of object creation. In other embodiments, such as when editing, a default value from a database may be used. When the user interface is rendered, the default values of configuration properties may be set to an initial value. The configuration properties may be serialized and saved as part of the business object. In an edit mode, the saved properties may be de-serialized and returned to a user interface where the properties may be changed and then rendered and/or serialized and re-saved.

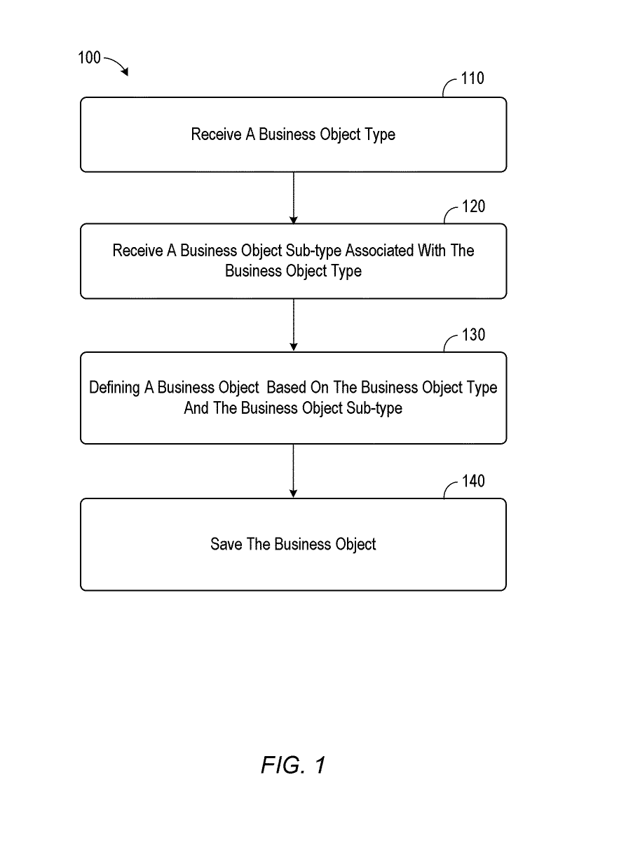

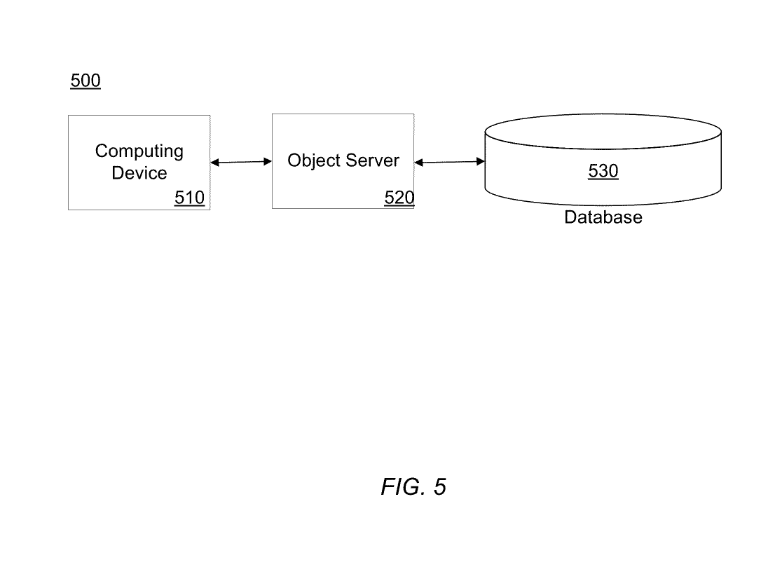

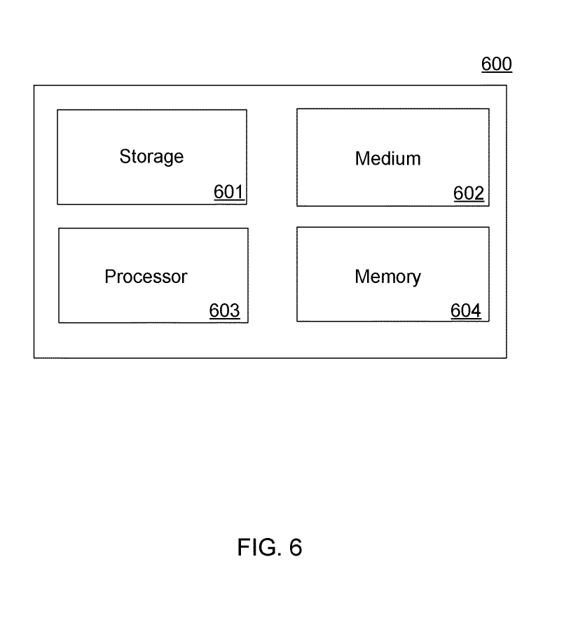

Turning now in detail to the drawings, FIG. 1 is a flow chart that illustrates a method 100 that may be performed according to some embodiments. The flow chart in FIG. 1 does not imply a fixed order to the steps, and the present embodiments can be practiced in any order that is practicable. Moreover, the methods may be performed by any of the devices described herein. The method shown in FIG. 1 may be performed, for example, by the system 500 of FIG. 5 and the apparatus 600 of FIG. 6. The method 100 may be embodied on a non-transitory computer-readable medium.

At 110 of FIG. 1, a business object type is received. A business object may comprise a software object that includes attributes and functions and is modeled to describe an object. A business object type, therefore, may comprise a type of object that is described by attributes and functions. For example, a business object may comprise a reader that is used to import information into a system. Another example of a business object might be a loader which loads information into a target and, in some embodiments, prepares the information for execution.

Readers and loaders may be used to transfer data from a source to a target. For example, a reader object may be used to transfer source data and a loader object may be used to transfer target data. There are many types of data sources and targets, such as SAP HANA, Oracle, DB2, file format, web services, etc. Each particular type of data sources may comprise different options (e.g., configuration properties) for a user to configure in order to create a user interface that fits a user's needs.

Each reader/loader business object type may comprise a plurality of sub-types such as, but not limited to, SAP Business Suite Applications, SAP HANA application cloud, file format, database, web Service, and adapter.

For illustrative purposes, and to aid in understanding features of the specification, an example will be introduced. This example is not intended to limit the scope of the claims. For example, a user may be provided a list that comprises a plurality of business object types. In the present example, the user may select a reader type business object from the list of business object types.

Next, at 120, a business object sub-type associated with the business object type is received. Each business object may comprise a plurality of sub-types that more narrowly define the business object type. Continuing with the above example, a user may be provided a list that comprises a plurality of business object sub-types that are related to the selected business object type. In the present example, the user selected a reader type business object type from the list of business object types. Business object sub-types that are related to “reader” may comprise “file format” or “database” which can indicate a type of file format that will be read or a type of database that may be read. In the present example, a business object sub-type of database may be selected. In some embodiments, a business object sub-type may have sub-types of its own (e.g., sub-sub-types). For example, sub-sub types of a database sub-type may comprise a type of database (e.g., SAP HANA, Oracle, DB2, etc.).

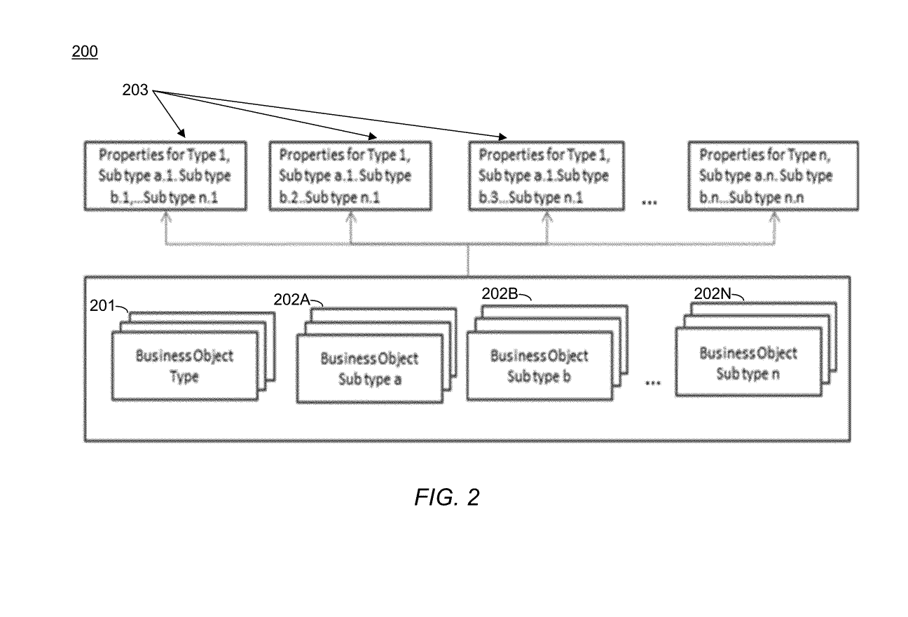

Now referring to FIG. 2, an embodiment of a business object 200 is illustrated. FIG. 2 may illustrate a visual example of the relationship between a business object types and sub-types. Business object 200 may include a business object type 201 and one or more business object sub types 202a, 202b through 202n. In the illustrated example, each business object type 201 may comprise layers of sub-types 202a-202n. Each business object 200 may comprise different configuration properties 203 that are based on their particular selection of business object types and sub-types. The configuration properties may be handled according to their particular business object types and sub-types. As illustrated in FIG. 2, a business object 200 may, for example, comprise a sub-type a.1, a sub-type b.3 through sub-type n.1 where the first digit (e.g., sub-type a through n) may indicate the kind of sub-type and the second digit may indicate a particular selection within the kind of sub-type.

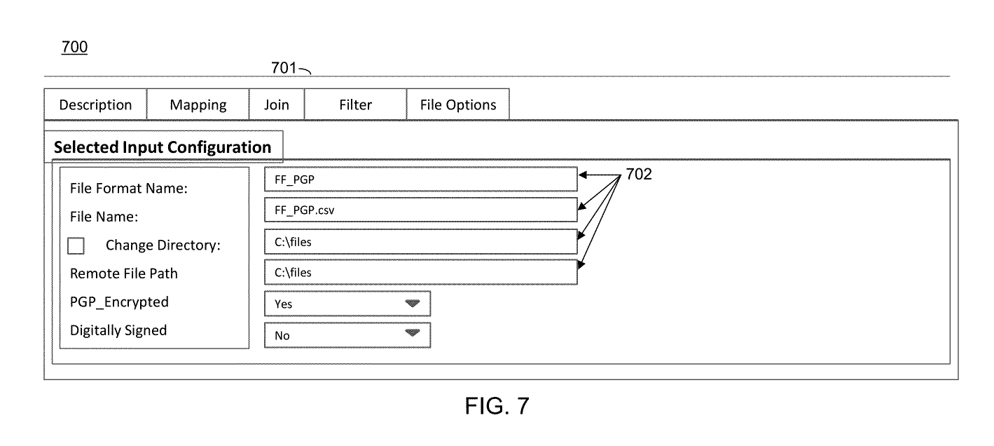

Referring now to FIG. 7, an embodiment of a user interface 700 displaying user options is illustrated. The user interface 700 comprises, for example, a GUI 701 that includes a plurality of options 702 associated with a reader. In the present example, the type reader has a sub-type of “File Format” and the plurality of options 702 are related to “File Format”. As illustrated, the plurality of options for “File Format” may comprise, but is not limited to, File Format Name, File Name, Change Directory, Remote File Path, PGP_Encrypted, and Digitally Signed. Each of the plurality of options 702 may be editable by a user.

Referring back to FIG. 1, at 130, a business object based on the business object type and the business object sub-type may be defined. The business object may be defined by a processor, such as that described with respect to FIG. 6, by aggregating business object types, business object sub-types and any associated configuration properties. The business object may be saved at 140. In some embodiments, the business object may be saved in a database. Continuing with the above example, a business object with a type “reader” and a sub-type of “database” may be combined and saved with any configuration properties required to execute or view the business object.

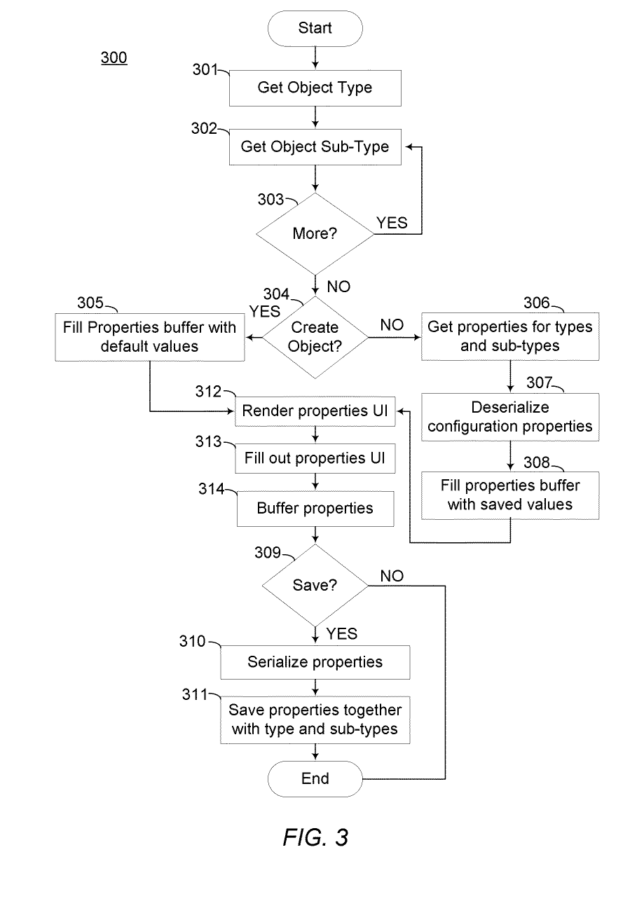

Referring now to FIG. 3, an embodiment of a flow diagram 300 is illustrated. The flow diagram 300 may relate to configuring a business object and rendering a user interface associated with a business object.

At 301, a business object type is selected. For example, a business object type may comprise a reader or a loader. At 302, a sub-type associated with the business object type may be selected. Since a business object type may comprise a plurality of sub-types, a determination may be made at 303 as to whether or not more sub-types will be selected.

After all desired sub-types, and in some embodiments, sub-sub types, are selected, a determination may be made as to whether or not a new business object will be created. If a new business object will be created, default values related to properties of the business object may be stored in a buffer at 305. This may allow multiple business objects to be created and saved together from a single buffer or information from different user interface pages may be collected and saved together. In some embodiments, when defining a business object such as flow element, the business object may have a reader or a loader type, and then, accordingly, a source of data and a target of data may be defined. After defining the source of data, a business object sub-type may be known and sub-type(s) of the business object type may also be known. In a case of creation of a business object of a specific type and/or sub-types, default values associated with properties of the business type and sub-types may be also be defined. The default values may be system defined and based on type and subtypes.

The default values may be saved to a buffer and then used for UI rendering in a creation mode. Otherwise, properties may be retrieved from a database, de-serialized and the configuration properties may be modified by a user. Then, in some embodiments, an input screen may be displayed and a user may fill out options (e.g., configuration properties) along with other data flow information. After a user enters information, the options may be serialized and saved, for example, into a database.

Referring back to 304, if a new business object will not be created (e.g., a saved business object will be used, at least in part, for rendering), properties for type and sub-types from an existing business object may be retrieved at 306. The properties for types and subtypes may be de-serialized at 307. At 308, saved values from the retrieved business object may be placed in the buffer. In some embodiments, only selected configuration properties from the business object may be saved in the buffer.

At 312, properties that were buffered may be rendered as part of a user interface. A user may enter configuration properties in the user interface at 313 and each of the properties may be buffered. If the business object is saved at 309, the properties in the buffer may be serialized at 310 and then saved together with other types and sub types of business objects at 311.

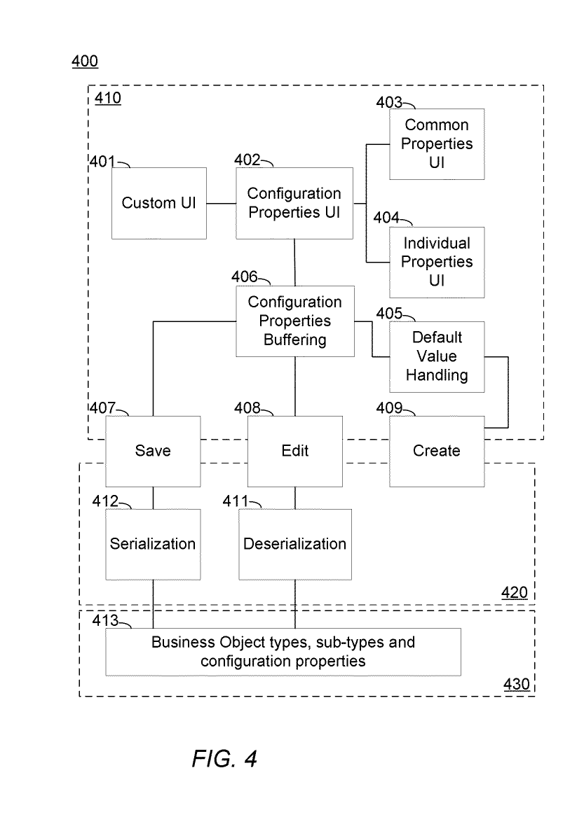

FIG. 4 illustrates a block diagram 400 that relates to different building blocks that are used to configure and render business object properties. The block diagram 400 may relate to saving 407 editing 408 and creating 409 business objects using a layered approach. The block diagram 400 illustrates the following layers: a view layer 410 for common and individual properties user interface rendering, a controller layer 420 for property related action processing and persistence layer interaction, and a persistence layer 430 that saves the business object properties, types and sub-types. At the controller layer 420, the solution is to provide object configuration properties such as create 409, delete (not shown), and edit 408. Editing 408 may comprise editing existing object type and sub-types in the context of a business object.

In some embodiments, the layers may be associated with Java, Javascript or C/C++. For example, the view layer 410 may be implemented using JavaScript and HTML5 and JavaScript files. The control layer 420 may be implemented using Java and Java Servlet and the view layer 410 and controller layer 420 may communicate using Asynchronous JavaScript and XML (“AJAX”) and JavaScript Object Notation (“JSON”) data formats. The persistence layer 430 may, for example, use SAP HANA for storing business objects.

Since a type (e.g., a reader and a loader) may each comprise different options and each sub-type may comprise different options. The reader/loader options may be accessible via a user interface (e.g., a data flow wizard) as illustrated in FIG. 7. Each type of option may be associated with a view that is displayed as part of a user interface. Some options may be considered common options while other options may be considered individual options. However, the options view may also be viewed as a combination of common views and individual views that are defined by a system.

The view layer 410 comprises a configuration properties user interface 402 that may allow a user to create user interfaces for different types of data sources. Each data source may comprise different options/properties for a user to configure to create a user interface based on the user's needs. The configuration properties user interface 402 may consolidate properties associated with a common properties user interface 403 and an individual properties user interface 404. The common properties user interface 403 may relate to common properties for each business object type and sub-types that will be created for view sharing purpose. Common properties comprise properties that will be common across a business object type and/or a business object sub type. For example, each business object of type reader may have a specific set of common properties that can be rendered for viewing purposes.

However, certain properties related to specific sub-types may have unique or individual properties which may be handled by the individual properties user interface 404. These individual properties 404 may be used to create individual views that display individual properties associated with specific sub types. Properties associated with common views and individual views may be combined to form a configuration options view that is used in a custom view via a custom user interface 401. Customer views may be rendered in a custom page of a user interface.

Prior to a user interface being rendered, default value settings for different types and subtypes may be selected. The default values may be used for properties rendering and each default value for each type or sub-type may be buffered first prior to the user interface being rendered at configuration properties buffering 406. Default values may be handled by a default value handler 405. Configuration properties buffering 406 may also allow a developer to use a plurality of business objects for a single user interface or allow the developer to input properties in different pages and save the different pages at the same time, and, when rendered, the user interface may be rendered with each of the buffered default values for the plurality of business objects for creation mode. If default values are not used, saved property values may be used. The saved values may be obtained by de-serializing a previously saved business object and using the default values from the previously saved business object.

As stated above, properties will first be buffered for user interface rendering. In order for the control layer 420 to correctly process business objects, property definitions in the view layer 410 and controller layer 420 may be kept in sync. The view layer 410 may comprise a user interface control process for (i) adding properties and (ii) canceling properties creation without interacting with the controller layer 420 and persistence layer 430 when it is not necessary. Furthermore the user interface control process may keep the control layer 420 and view layer 410 in sync with main business object processing.

When in edit mode 408, de-serialization 411 may be triggered to de-serialize saved business object configuration properties and return the de-serialized configuration properties to a user interface (e.g., the view layer 410) for processing. When in save mode 407, serialization 412 may be triggered to serialize (e.g., name-value pairs) the business object configuration properties from the view layer 410 and the configuration properties may be saved as part of a business object in the persistence layer 430. Default value handling may also be provided in the control layer 420.

The business object configuration properties may be saved in the business object after serialization along with the business object type and sub types. For example, when save is triggered, the options in the buffer may be used for serialization and saved into a database 413 that comprises business object types, sub-types and configuration properties.

Now referring to FIG. 5, an embodiment of a system 500 is illustrated. The system 500 may comprise a computing device 510 in communication with an object server 520. The object server will be described in more detail with respect to FIG. 6. The object server 520 may be in communication with a database 530. The computing device 510 may comprise a device that is used by a user to enter data associated with business objects and/or to select business object types and/or sub-types. The database 530 may comprise a database to store business objects and related information. The database 530 may be internal or external to the object server 520.

Now referring to FIG. 6, an embodiment of an apparatus 600 is illustrated. In some embodiments, the apparatus 600 may be associated with an object server 520.

The apparatus 600 may comprise a storage device 601, a medium 602, a processor 603, and a memory 604. According to some embodiments, the apparatus 600 may further comprise a digital display port, such as a port adapted to be coupled to a digital computer monitor, television, portable display screen, or the like.

The medium 602 may comprise any computer-readable medium that may store processor-executable instructions to be executed by the processor 603. For example, the medium 602 may comprise a non-transitory tangible medium such as, but not limited to, a compact disk, a digital video disk, flash memory, optical storage, random access memory, read only memory, or magnetic media.

A program may be stored on the medium 602 in a compressed, uncompiled and/or encrypted format. The program may furthermore include other program elements, such as an operating system, a database management system, and/or device drivers used by the processor 603 to interface with peripheral devices.

The processor 603 may include or otherwise be associated with dedicated registers, stacks, queues, etc. that are used to execute program code and/or one or more of these elements may be shared there between. In some embodiments, the processor 603 may comprise an integrated circuit. In some embodiments, the processor 603 may comprise circuitry to perform a method such as, but not limited to, the method described with respect to FIG. 1.

The processor 603 communicates with the storage device 601. The storage device 601 may comprise any appropriate information storage device, including combinations of magnetic storage devices (e.g., a hard disk drive), optical storage devices, flash drives, and/or semiconductor memory devices. The storage device 601 stores a program for controlling the processor 603. The processor 603 performs instructions of the program, and thereby operates in accordance with any of the embodiments described herein.

The main memory 604 may comprise any type of memory for storing data, such as, but not limited to, a flash driver, a Secure Digital (SD) card, a micro SD card, a Single Data Rate Random Access Memory (SDR-RAM), a Double Data Rate Random Access Memory (DDR-RAM), or a Programmable Read Only Memory (PROM). The main memory 604 may comprise a plurality of memory modules.

As used herein, information may be “received” by or “transmitted” to, for example: (i) the apparatus 600 from another device; or (ii) a software application or module within the apparatus 600 from another software application, module, or any other source.

In some embodiments, the storage device 601 stores a database (e.g., including information associated with business objects). Note that the database described herein is only an example, and additional and/or different information may be stored therein. Moreover, various databases might be split or combined in accordance with any of the embodiments described herein. In some embodiments, an external database may be used.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method of defining a business object comprising:
receiving a business object type;
receiving a business object sub-type associated with the business object type;
defining, via a processor, a business object based on the business object type and the business object sub-type; and
saving the business object.

2. The method of claim 1, further comprising:
receiving a sub-sub type associated with the sub-type; and
defining, via the processor, the business object based on the business object type, the business object sub-type and the sub-sub type.

3. The method of claim 2, wherein prior to determining the business object, determining if more business object sub-types are received.

4. The method of claim 1, wherein saving comprises serializing the business object into name-value pairs that comprises the business object type and the business object sub-type.

5. The method of claim 4, further comprising:
editing the business object by de-serializing the saved business object; and
re-saving the edited business object by serializing the edited business object into name-value pairs.

6. The method of claim 1, further comprising:
rending the business object in a user interface where the rendered user interface comprises first attributes associated with the received business object type and second attributes associated with the received business object sub-type.

7. The method of claim 1, wherein a business object comprises a software object comprising attributes and functions that is modeled to describe an object.

8. A non-transitory computer-readable medium comprising instructions that when executed by a processor perform a method of defining a business object, the method comprising:
receiving a business object type;
receiving a business object sub-type associated with the business object type;
defining, via a processor, a business object based on the business object type and the business object sub-type; and
saving the business object.

9. The medium of claim 8, further comprising:
receiving a sub-sub type associated with the sub-type; and
defining, via the processor, the business object based on the business object type, the business object sub-type and the sub-sub type.

10. The medium of claim 9, wherein prior to determining the business object, determining if more business object sub-types are received.

11. The medium of claim 8, wherein saving comprises serializing the business object into name-value pairs that when saved, comprise the business object type and the business object sub-type.

12. The medium of claim 11, further comprising:
editing the business object by de-serializing the saved business object properties; and
re-saving the edited business object by serializing the edited business object properties into name-value pairs.

13. The medium of claim 8, further comprising:
rending the business object in a user interface where the rendered user interface comprises first attributes associated with the received business object type and second attributes associated with the received business object sub-type.

14. An apparatus comprising:
a processor; and
a non-transitory computer-readable medium comprising instructions that when executed by a processor perform a method of defining a business object, the method comprising:
receiving a business object type;
receiving a business object sub-type associated with the business object type;
defining, via the processor, a business object based on the business object type and the business object sub-type; and
saving the business object.

15. The apparatus of claim 14, wherein the method further comprises:
receiving a sub-sub type associated with the sub-type; and
defining, via the processor, the business object based on the business object type, the business object sub-type and the sub-sub type.

16. The apparatus of claim 15, wherein prior to determining the business object, determining if more business object sub-types are received.

17. The apparatus of claim 14, wherein saving comprises serializing the business object properties into name-value pairs that when saved, comprise the business object type and the business object sub-type.

18. The apparatus of claim 17, wherein the method further comprises:
editing the business object by de-serializing the saved business object properties; and
re-saving the edited business object by serializing the edited business object properties into name-value pairs.

19. The apparatus of claim 14, further comprising:
rending the business object in a user interface where the rendered user interface comprises first attributes associated with the received business object type and second attributes associated with the received business object sub-type.

20. The apparatus of claim 14, wherein a business object comprises a software object comprising attributes and functions that is modeled to describe an object.
